(19) United States
(12) Patent Application Publication
(10) Pub. No.: US 2007/0100853 A1
(43) Pub. Date: May 3, 2007

(54) Data collection from network nodes in a telecommunication network

(75) Inventors: Andrea Paparella, Busto Arsizio (Varese) (IT); Roberto Riglietti, Vimercate (Milano) (IT); Pasquale Donadio, Napoli (IT)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/488,052

(22) Filed: Jul. 18, 2006

(30) Foreign Application Priority Data
Oct. 27, 2005 (EP) 05292302.6

(51) Int. Cl. G06F 7/00

(52) U.S. Cl. 707/100

(57) ABSTRACT

It is disclosed a method for collecting data from nodes of a telecommunication network, said network comprising a collecting node and an intermediate node, the method comprising the steps, which are performed by the intermediate node, of: receiving from said collecting node a first file comprising at least a first compressed data set and a first dictionary; generating a second file comprising at least a second compressed data set and a second dictionary; merging said first dictionary and said second dictionary into a resulting dictionary; and inserting said resulting dictionary, said first compressed data set and said second compressed data set into an overall file. Also disclosed are a network node and a network manager for implementing the method.

### BACKGROUND OF THE INVENTION

1. Field of the Invention

The present invention relates to a method for collecting data from network nodes in a telecommunication network. The present invention further relates to a network node and a network manager for implementing such a method and a telecommunication network wherein such a method is implemented.

This application is based on and claims the benefit of European Patent Application No 05 292 302.6 filed on Oct. 27, 2005, which is incorporated by reference herein.

2. Description of the Prior Art

A telecommunication network typically comprises a plurality of network nodes. Such network nodes are adapted to route and switch traffic flows across the network.

In a telecommunication network, network nodes are typically managed in a centralised way by a network manager. The network manager is adapted to collect information from nodes, and to perform proper actions on nodes according to such collected information. For instance, a network manager may collect performance information from nodes, and then it can act upon nodes so that performance is kept at an acceptable level. Besides, for instance, a network manager may collect configuration information relating to software versions in network nodes, and then it can distribute software updates to network nodes. And so on.

In the following description and in the claims, the expression “data set” will indicate a set of information collected by a network manager from a network node, independently from the type of collected information (performance information, configuration information, accounting information, backup, or the like) comprised in such a data set.

Collecting data in a telecommunication network may be performed in a centralised way, wherein each network node being connected (directly or through other network nodes) to the network manager. In this case, the network manager collects from each single node its respective data set through a dedicated management channel. For instance, in SDH (“Digital Synchronous Hierarchy”) networks, such data sets are collected through a so-called Data Communication Channel (DCC).

However, in some cases, the dedicated channel bandwidth may be rather narrow (e.g., 176 kbit/s for the above DCC). In view of the fact that network nodes are becoming even more complex and they require an increasing amount of management information, the average size of data sets is increasing. As a consequence, collecting data sets from each of the network nodes through the DCC channel takes a very long time, and the overall data collection time may become unacceptable.

### SUMMARY OF THE INVENTION

An object of the present invention is providing a method for collecting data from network nodes in a telecommunication network which allows to reduce the overall data collection time in a network in comparison with the known methods.

According to a first aspect, the present invention provides a method for collecting data from nodes of a telecommunication network, said network comprising a collecting node and an intermediate node, the method comprising the steps, which are performed by said intermediate node, of: receiving from said collecting node a first file comprising at least a first compressed data set and a first dictionary; generating a second file comprising at least a second compressed data set and a second dictionary; merging said first dictionary and said second dictionary into a resulting dictionary; and inserting said resulting dictionary, said first compressed data set and said second compressed data set into an overall file.

The above steps of receiving and generating can be performed in any order. In other words, the step of receiving could be performed before, after or at the same time as the step of generating.

Preferably, the step of generating a second file comprises a step of generating said compressed data set by using at least a dictionary entry which is stored in said intermediate node.

Preferably, it is inserted in said overall file a first header including an identifier of said collecting node and a second header including an identifier of said intermediate node.

Preferably, the overall file is forwarded according to routing information stored at said intermediate node.

According to a second aspect, the present invention provides a network node of a telecommunication network, wherein it comprises: receiving means for receiving a first file comprising at least a first compressed data set and a first dictionary; a compression module for generating a second file comprising at least a second compressed data set and a second dictionary; a merging module for inserting said first compressed data set and said second compressed data set into an overall file, and for merging said first dictionary and said second dictionary in said overall file.

Advantageously, the compression module is further adapted to generate said second file according to at least a dictionary entry which is stored at said network node.

Advantageously, the merging module is further adapted to insert in said overall file a header including an identifier of said network node.

The network node, preferably, comprises a forwarding module for forwarding said overall file according to routing information stored at said network node.

According to a third aspect, the present invention provides a network manager of a telecommunication network comprising: receiving means for receiving a file comprising a first compressed data set, a second compressed data set and a sequence of dictionary entries; a decompression module for decompressing said first compressed data set and said second compressed data set according to said sequence of dictionary entries.

The decompression module is preferably further adapted to decompress said first compressed data set and said second compressed data set according to at least a dictionary entry which is stored at said network manager.

According to a fourth aspect, the present invention provides a telecommunication network comprising a network node as set forth above and a network manager as set forth above.

The invention will become more clear by the following description, given by way of example and not of limitation, to be read with the accompanying drawings.

### BRIEF DESCRIPTION OF THE DRAWINGS

In the drawings:

FIG. 1 schematically shows a simplified telecommunication network which is adapted to implement the method of the invention;

FIGS. 2a and 2b schematically show the structure of a node and the structure of the network manager of the network of FIG. 1, respectively;

FIG. 3 shows a flow chart of some operations performed by the nodes of FIG. 1;

FIG. 4 schematically shows the operation of the node NA of FIG. 1;

FIG. 5 schematically shows the operation of the node NB of FIG. 1;

FIGS. 6a and 6b schematically show the structure of a node and the structure of the network manager of the network of FIG. 1, respectively, according to a preferred embodiment of the present invention; and

FIGS. 7a and 7b show an example of application of the method of the invention to a ring network.

### BEST MODE FOR CARRYING OUT THE INVENTION

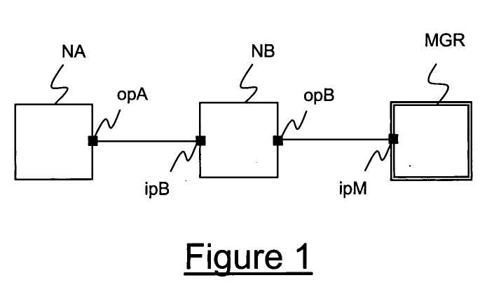

FIG. 1 schematically shows a simplified telecommunication network wherein the network according to the present invention could be implemented and easily explained.

The network of FIG. 1 comprises a node NA, a node NB connected to the node NA and a network manager MGR (for instance, the NOC of an SDH network), which is connected to the node NB.

Square markers indicate the input ports and the output ports of each node. For clarity reasons, FIG. 1 only shows the input/output ports which are relevant to the present invention. In particular, the node NA has an output port opA, which is connected to an input port ipB of the node NB. Similarly, the node NB has an output port opB which is connected to an input port ipM of the network manager MGR.

The network of FIG. 1 is only exemplary; indeed, the method of the invention can be applied to networks comprising any number of nodes, arranged according to any topology (bus, ring, mesh), as it will be shown herein after.

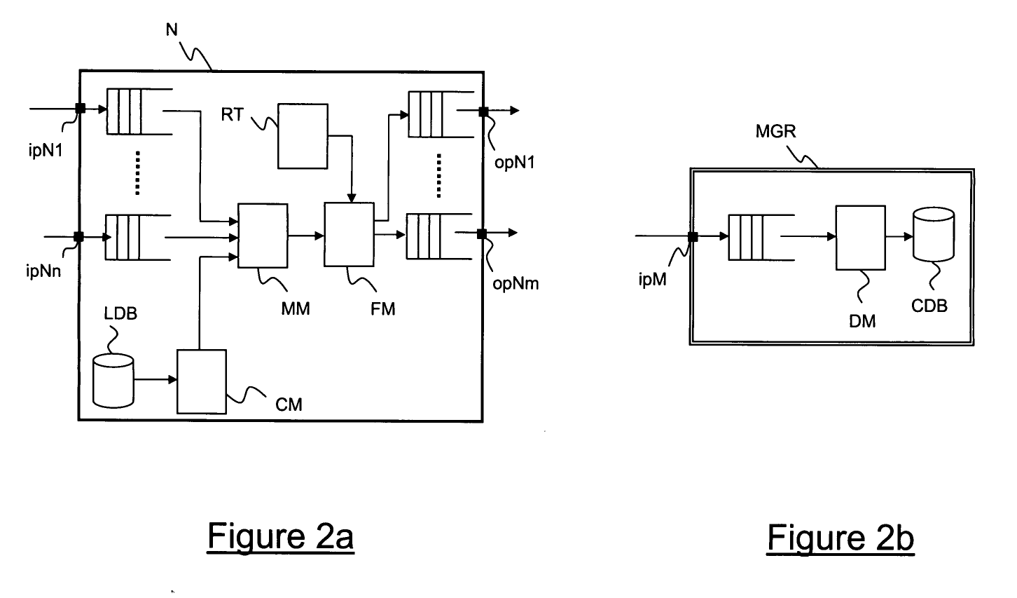

FIG. 2a schematically shows the structure of any of nodes NA, NB of FIG. 1 (generically termed N) according to the present invention.

The node N comprises n input ports ipN1, . . . ipNn. The node N further preferably comprises a local database LDB, which is connected to a compression module CM. The input ports ipN1, . . . ipNn and the compression module are connected to a merging module MM. The merging module MM and a routing table RT are preferably connected to a forwarding module FM, which is in turn connected to m output ports opN1, . . . opNm.

FIG. 2b schematically shows an exemplifying structure of the network manager MGR of FIG. 1 according to the present invention.

The network manager MGR preferably comprises at least an input port (FIG. 2b only shows a single input port ipM), a decompression module DM and a centralised database CDB.

The node N and the network manager MGR may comprise further modules and input/output ports, which are not shown into the Figures, as they are not relevant to the present description.

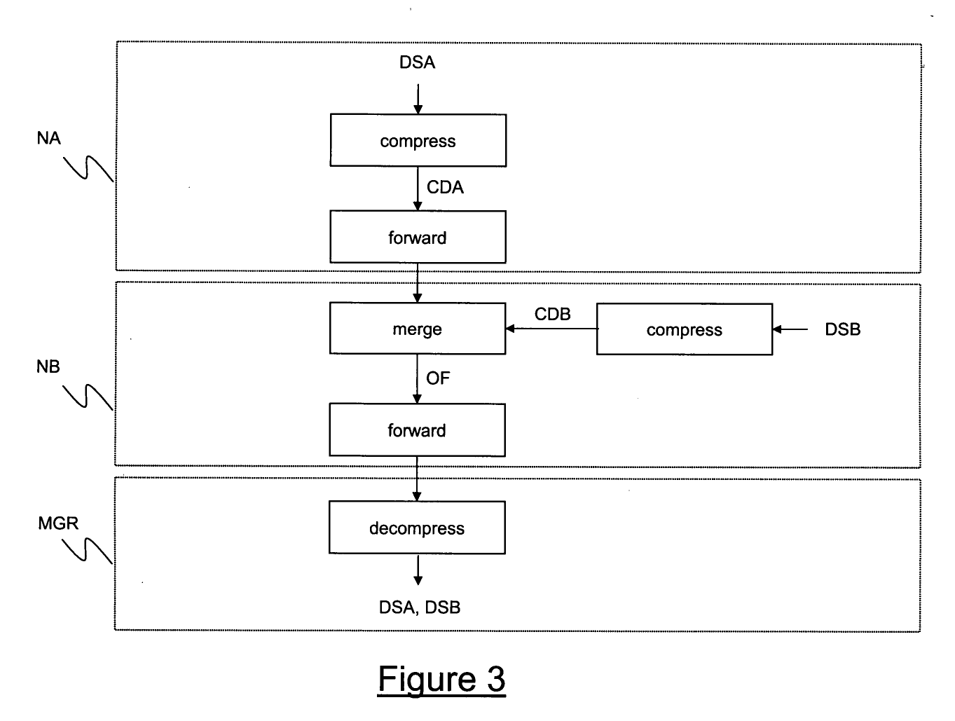

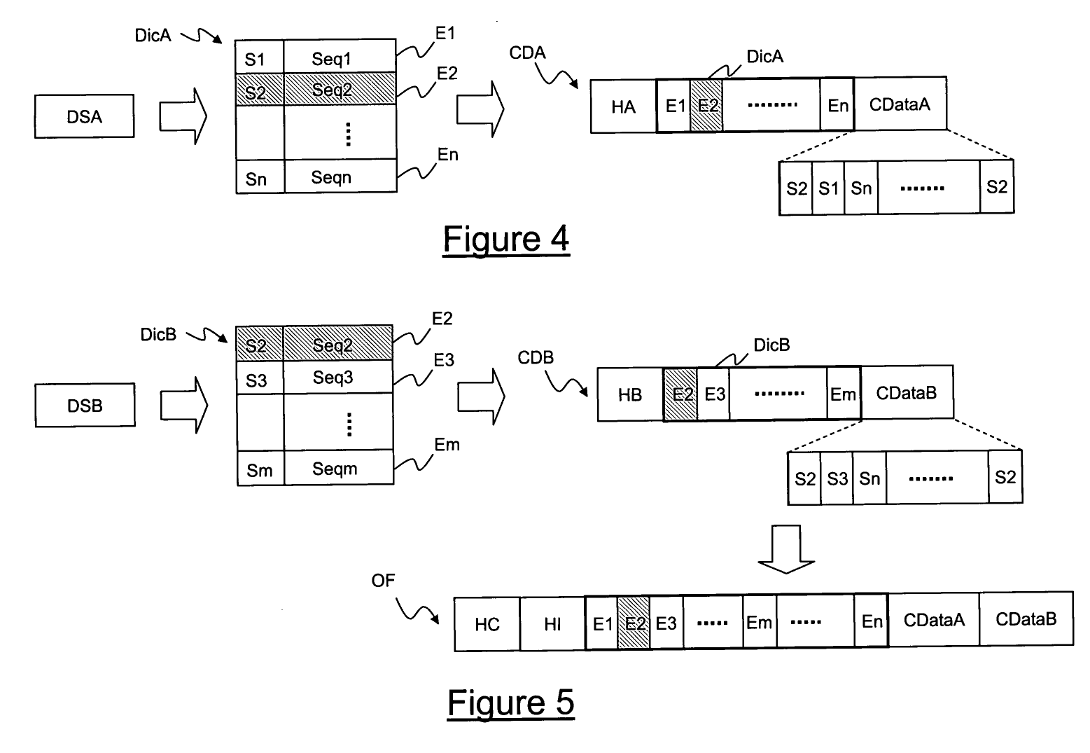

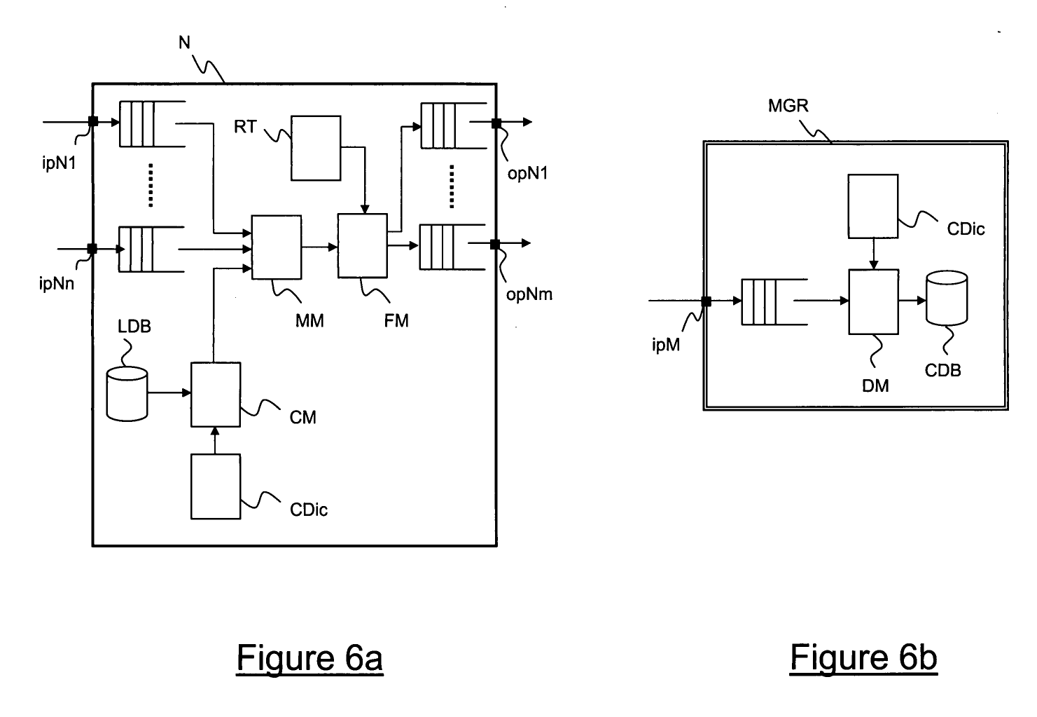

By making reference to FIG. 3, the method of collecting data into the network of FIG. 1 according to the present invention will now be briefly described. Greater details about the operations performed by each node will be given herein after by referring to FIGS. 4 and 5.

For instance, it is assumed that the network manager MGR has to perform a backup of the local databases LDB of the nodes NA and NB of the network of FIG. 1. For this purpose, the network manager MGR has to collect from each node NA, NB a respective data set DSA, DSB, each data set DSA, DSB comprising a copy of the local database content of the respective node NA, NB.

According to the present invention, the node NA firstly compresses its own data set DSA and inserts it into a file CDA, together with a header and other information for data decompression, as it will be explained in greater detail herein after. Then, the node NA forwards the file CDA to the node NB.

Similarly, according to the present invention, the node NB compresses its own data set DSB and inserts it into a file CDB, together with a header and other information for data decompression.

Then, the node NB merges its own file CDB with the file CDA received from NA, as it will be explained in greater detail herein after, thus obtaining an overall file OF. Data of files CDA, CDB may be not contiguous within the overall file OF. The structure of files CDA, CDB and OF will be described in greater details herein after.

The node NB then forwards the overall file OF to the network manager MGR, which decompresses the overall file OF, and recovers the data sets DSA, DSB.

A node performing only compression of its own data set, in the following description and in the claims, will be termed “collecting node”. Besides, a node performing both compression of its own data set and merging of its own file and at least a file received from another node will be termed “intermediate node”. Thus, in the network of FIG. 1, NA is a collecting node, while NB is an intermediate node.

With reference to FIG. 4, the operation of the collecting node NA according to the present invention will be now described in greater detail.

According to the present invention, the node NA reads from its local database the data set DSA, and it compresses it through its own compression module CM.

In a preferred embodiment of the present invention, the compression module CM implements a compression algorithm with dictionary. Such compression algorithms with dictionary are known in the art. They associate a symbol to frequent or long byte sequences, and they build a dictionary, i.e. a table wherein each entry biunivocally associates a symbol to a respective byte sequence.

Preferably, according to the invention, the compression algorithm with dictionary is able to recognise (i.e. to associate to a single symbol) long byte sequences, which possibly correspond to a whole data set. A suitable algorithm is, for instance, a LZMA compression algorithm. Such a type of compression algorithm allows to reach particularly high compression rates.

The compression algorithm thus builds a dictionary DicA with n entries E1, E2, . . . En, wherein each entry biunivocally associates a byte sequence Seq1, Seq2, . . . , Seqn of the data set DSA to a respective symbol S1, S2, . . . , Sn.

Though not shown in FIG. 4, the compression algorithm with dictionary may also associate a single symbol to a sequence of symbols which is particularly long or frequent. For instance, if the symbol sequence “S1, S2” is repeated more than once in the data set DSA, it can be replaced by a single symbol Sk. This allows to compress a whole data set in a single symbol. Therefore, in FIG. 4, reference signs Seq1, Seq2, . . . , Seqn indicate either a byte sequence or a symbol sequence.

Once dictionary DicA has been built, the compression module of the node NA replaces each sequence Seq1, Seq2, . . . , Seqn of the data set DSA with each respective symbol S1, S2, . . . , Sn, thus obtaining a compressed data set CDataA. Again, it is remarked that the compressed data set CDataA may be formed by few symbols, or even by a single symbol.

The node NA then creates a file CDA, comprising a header HA, the entries E1, E2, . . . , En of the dictionary DicA and the compressed data set CDataA.

According to present invention, the header HA may comprise one or more of the following parameters:
source node identifier;
network manager identifier. In a preferred embodiment of the present invention, such a network manager identifier is the IP address of the network manager, as it will be explained herein after;
data set name;
update version;
base version;
list of symbols S1, S2, . . . , Sn of the dictionary DicA;
compressed data set offset; and
compressed data set size (expressed in words).

According to the routing table RT, the forwarding module FM of the node NA determines the output port through which the file CDA must be forwarded. According to a preferred embodiment of the present invention, the network manager identifier is its IP address. Thus, the routing table RT is an IP routing table.

It is known that a routing table indicates, for each IP address range, the output port towards which data addressed to a node whose IP address is comprised within such a range must be forwarded. By referring to FIG. 1, the IP address of the network manager MGR belongs to the IP address range associated to the only output port opA. Thus, the file CDA is sent to the node NB through such an output port opA.

FIG. 5 schematically shows the operation of the intermediate node NB according to the present invention.

The intermediate node NB receives the file CDA from the node NA through its input port ipB. Furthermore, the intermediate node NB reads from its local database LDB its data set DSB, and it compresses it through the same compression algorithm with dictionary used by NA. Thus, the intermediate node NB builds a dictionary DicB.

The dictionary DicB comprises m entries E2, E3, . . . , Em. It must be noticed that also in DicB, each sequence Seq2, Seq3, . . . , Seqm may be either a byte sequence or a symbol sequence.

Some entries may be comprised both in DicA and in DicB; other entries may be comprised only in DicA, other entries may be comprised only in DicB. For instance, in the example of FIGS. 4 and 5, the entry E1 is comprised only in DicA; the entry E2 is comprised both in DicA and in DicB; the entry E3 is comprised only in DicB. The other entries are omitted for simplicity.

By using the dictionary DicB, the node NB compresses the data set DSB, i.e. it replaces each sequence Seq2, Seq3, . . . , Seqm with the respective symbol S2, S3, . . . , Sm, thus obtaining a compressed data set CDataB. Again, it is remarked that the compressed data set CDataB may be formed by few symbols, or even by a single symbol.

The intermediate node NB then builds a file CDB, whose structure (shown in FIG. 5) is similar to the structure of the file CDA. The file CDB comprises a header HB, the entries E2, E3, . . . , Em of the dictionary DicB and the compressed data set CDataB. The content of the header HB is preferably similar to the content of the above header HA.

The Applicant has observed that data sets from nodes of a same telecommunication network sometimes exhibit a strong correlation, i.e. they may contain many identical byte sequences. The Applicant has thus observed that forwarding separately two substantially identical files to the network manager would imply a waste of bandwidth. The Applicant has noticed that bandwidth could be saved by decompressing the file CDA at the node NB, and by applying the application algorithm to the whole of the data sets DSA, DSB, thus minimising the overall size of the data to be forwarded to the network manager.

Besides, the Applicant has noticed that there exist constraints on the overall collection data time in a telecommunication network. Such constraints are generally defined by the standards relative to a telecommunication network management. Thus, the Applicant has perceived that it is preferable to adopt an “intermediate solution”, which allows to comply with both bandwidth constraints and with data collection time constraints.

More particularly, the Applicant has perceived that, using a compression algorithm with dictionary, different files from different nodes can be merged without decompressing the single compressed data set.

More particularly, according to a preferred embodiment of the present invention, the node NB builds an overall file OF without decompressing CDA and CDB. Such a file OF, according to the present invention, comprises the two headers HA, HB and the compressed data sets CDataA, CDataB. As for the dictionaries DicA, DicB, the Applicant has perceived that, thanks to the possible correlation between the data sets DSA, DSB, the dictionaries DicA, DicB may comprise several common entries. In many applications, the dictionaries DicA and DicB substantially comprise the same entries. According to the present invention, the two dictionaries DicA, DicB are not separately inserted into the overall file OF, but they are merged before being inserted, i.e. the intermediate node NB inserts only once into the file OF all the entries comprised at least in one of the dictionaries DicA, DicB.

In the following description and in the claims, this latter operation will be referred to with the expression “merging two (or more than two) dictionaries”, which means that, according to the present invention, the merging module MM of an intermediate node, in order to merge its own file with one or more files received from another node, actually merges the dictionaries of such files, by inserting into the file OF all the entries belonging to at least one of the dictionaries to be merged.

Then, according to the present invention, entries which are comprised in more than one dictionary, which are possibly the greater part of the entries, are sent to the network manager only once. This is particularly advantageous for instance when data sets DSA, DSB are substantially identical. In this case, the dictionaries DicA, DicB are substantially identical. Therefore, instead of transmitting separately two dictionaries which are substantially identical, the intermediate node NB sends a single dictionary, which comprises the entries of both dictionaries DicA and DicB.

Therefore, in FIG. 5, it can be seen that the overall file OF comprises, in addition to the headers HA, HB and to the compressed data sets CDataA, CDataB, a sequence of entries E1, E2, E3, . . . Em, . . . En (where m is supposed to be lower than n). In particular, it can be noticed that such a sequence comprises all the entries of the dictionary DicA and all the entries of the dictionary DicB, wherein common entries are inserted into the overall file OF only once (as it can be seen in FIG. 5 with reference to the common entry E2).

Therefore, the overall file OF size is particularly reduced in comparison with the sum of the size of single compressed files CDA, CDB, as the size of each compressed file CDA, CDB is mainly due to the dictionary size therein comprised.

The Applicant has performed some tests by applying a LZMA compression algorithm (Lempel-Ziv-Markov chain-Algorithm) upon different data sets.

The Applicant has noticed that the compression efficiency increases by increasing the number of merged data sets, in particular if such data sets are substantially equal, i.e. if they exhibit a strong correlation. For instance, by merging different copies (two, three or four) of a same data set, the overall file OF size is substantially independent from the number of merged copies.

Therefore, as the node NB is able to merge the two files CDA, CDB without decompressing the received file CDA, the processing time required by the node NB is only due to the fact that the node NB, before merging, has to wait the complete reception of the file CDA. This advantageously results in processing times at node NB which are extremely reduced.

As already mentioned, after creating the overall file OF, the node NB, according to its routing table RT, determines the output port through which the overall file OF must be forwarded. Into the network of FIG. 1, there is only a single output port, which connects the node NB to the network manager MGR. Therefore, the node NB forwards the overall file OF to the network manager MGR. Upon reception of the overall file OF, the network manager decompresses it by using the entries E1, E2, E3, . . . , Em, . . . En comprised into the file OF, recovers the data sets DSA, DSB, and stores them into its centralised database CDB.

The network of FIG. 1 comprises only two nodes, and the path that the files can follow across the network is unique. However, it has to be noticed that, in networks with a higher number of nodes arranged according to a more complex topology, the path followed by data while performing data collection according to the present invention is preferably dynamically established hop-by-hop by each intermediate node, according to information comprised into its respective routing table and according to additional information such as traffic information, number and position of the collecting nodes, CPU usage percentage, memory availability, etc, so that Quality of Service requirements of the network can be accomplished. Therefore, according to the present invention, preferably, all the network nodes are able to act both as collecting nodes and as intermediate nodes, i.e. all the network nodes comprise a merging module MM. This advantageously allows to have maximum flexibility in optimising a data collection in a network.

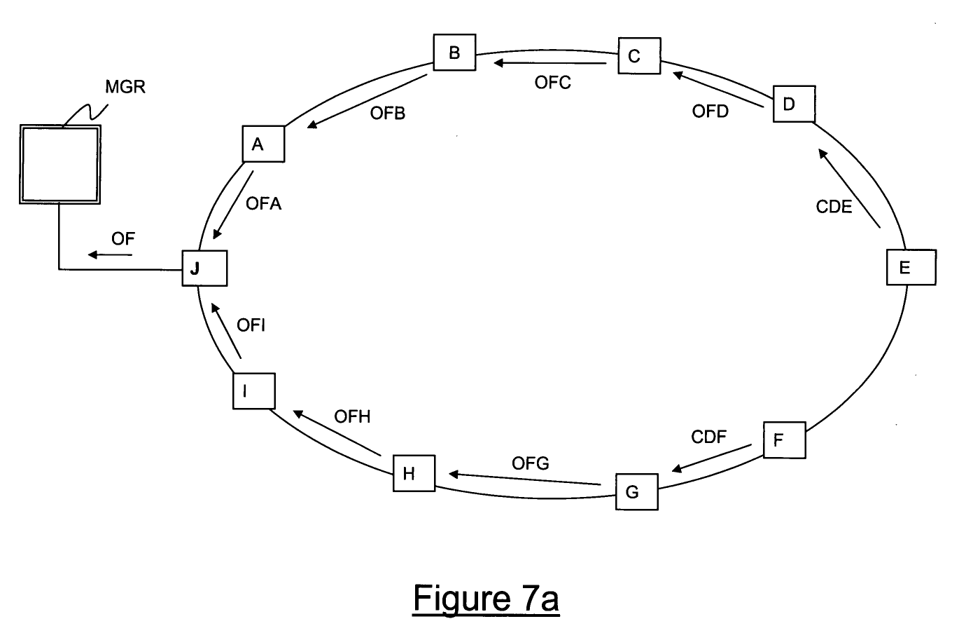

FIGS. 6a and 6b schematically show the structure of a node N (which may be either node NA or node NB) and of the network manager MGR of the network of FIG. 1, according to an advantageous embodiment of the present invention.

According to such an advantageous embodiment, a common dictionary, which comprises symbols that are most frequent into the data sets to be collected, is stored at each intermediate or collecting node of the network and also at the network manager, so that entries comprised into such a common dictionary do not need to be transmitted inside the overall file OF across the network each time a data collection is performed.

By still referring to FIG. 4, for instance, it is assumed that, among the different symbols S1, S2, . . . Sn, the symbol S2 (whose entry E2 is dashed in FIG. 4) is particularly frequent into the data sets that the network manager MGR usually collects from the nodes NA, NB. Such a symbol S2 is then inserted into a common dictionary CDic.

The common dictionary CDic, according to the present invention, is stored both at the network manager MGR and at each node NA, NB. Therefore, the network manager MGR has a common dictionary Cdic. The decompression module DM uses such a common dictionary for decompressing and recovering the data sets. Also each node N shown in FIG. 6a stores a copy of the common dictionary CDic, which the compression module CM uses for compressing data sets.

In particular, the decompression module DM of the network manager MGR is adapted to merge the entries of the common dictionary CDic with the entries extracted from the overall file OF, so that it has all the entries required for decompressing the received file OF.

This advantageously allows to further reduce the overall file size. Indeed, according to this preferred embodiment, the file OF does not comprise all the entries E1, E2, E3, . . . Em, . . . En of the dictionaries DicA, DicB, but only the entries which are not included into the common dictionary. Therefore, the time for transmitting the overall file OF to the network manager is reduced, thus allowing to further reduce the overall data collection time in a telecommunication network.

As already mentioned, the method according to the present invention may be applied also to networks with different topologies and with an arbitrary number of nodes.

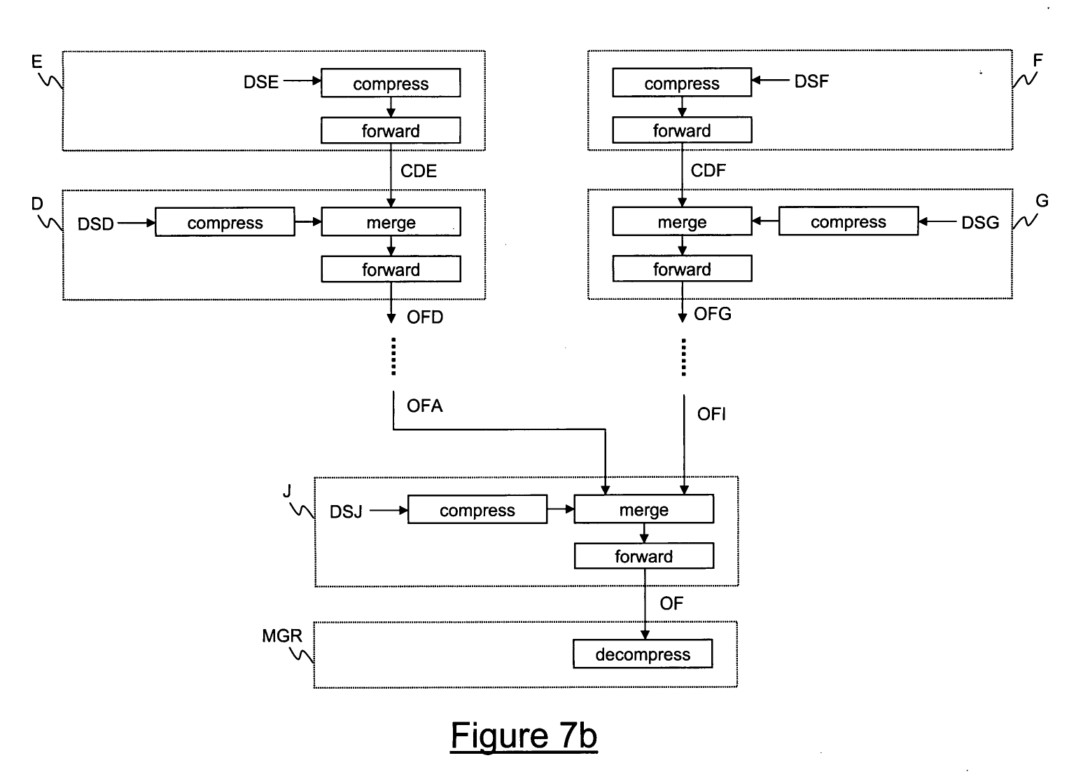

FIG. 7a shows an exemplary ring network with nine nodes A, B, C . . . J. Each node has a structure as shown in FIG. 2a or in FIG. 6a. The application of the method of the invention to the exemplary network of FIG. 7a will now be described by referring to FIG. 7b.

It is assumed that the network manager MGR has to perform a backup of the local databases of all the nodes A, B, C . . . J of the ring network of FIG. 7a.

According to the present invention, the node E compresses its own data set DSE and inserts it in a file CDE together with header and dictionary, as described above with reference to FIG. 1.

The node E may then decide whether to forward its file CDE to the node D or to the node F, according to its routing table. It is assumed that the node E decides to forward its file CDE to the node D.

The node D, upon reception of the file CDE from E, compresses its own data set DSD, it inserts it in a file CDD (not shown), it merges the file CDD with the file DCE received from E, and it forwards the overall file OFD to the following node, which is node C.

And so on, until node A. Node A merges its own file CDA with the overall file OFB received from node B, which comprises the merged files of nodes B-E, thus obtaining an overall file OFA. The node A forwards the file OFA to the node J.

The same happens starting from node F, through the nodes F, G, H, I.

Node J, upon reception of the overall file OFA from node A and an overall file OFI from node I, merges OFA, OFI and its file CDJ, which comprises its compressed data set DSJ, thus obtaining an overall file OF. Node J then forwards the overall file OF to the network manager MGR.

The network manager MGR decompresses the file OF, and stores the data sets of the nodes A, B, . . . J in its centralised database.

Then, it can be noticed that in the ring network of FIG. 7a, nodes E and F are collecting nodes, while all the other nodes are intermediate nodes.

Therefore, the method of the invention advantageously allows to reduce the data collection time from the nodes of a telecommunication network, for the following reasons.

Firstly, compressing data sets before forwarding them allows to send, for a given bandwidth of the management channel, a higher number of data sets, and thus it allows to collect data at a higher speed in comparison with the prior art. By using a compression algorithm with dictionary, compression becomes particularly efficient. Moreover, merging different compressed data sets according to the present invention allows to obtain a very high compression rate.

Moreover, each intermediate node is able to merge its own file with files received from other nodes without performing decompression. Therefore, processing time required by each intermediate node mainly depends on the reception time of files from other nodes, which is very low in comparison with decompression/compression time, thus resulting is a particularly low processing time.

1. A method for collecting data from nodes of a telecommunication network, said network comprising a collecting node and an intermediate node, the method comprising the steps, which are performed by said intermediate node, of:
receiving from said collecting node a first file comprising at least a first compressed data set and a first dictionary;
generating a second file comprising at least a second compressed data set and a second dictionary;
merging said first dictionary and said second dictionary into a resulting dictionary; and
inserting said resulting dictionary, said first compressed data set and said second compressed data set into an overall file.

2. The method according to claim 1, wherein said step of generating a second file comprises a step of generating said second compressed data set by using at least a dictionary entry which is stored in said intermediate node.

3. The method according to claim 1, wherein it further comprises a step of inserting in said overall file a first header including an identifier of said collecting node and a second header including an identifier of said intermediate node.

4. The method according to claim 1, wherein it further comprises a step of forwarding said overall file according to routing information stored at said intermediate node.

5. A network node of a telecommunication network, comprising:
receiving means for receiving a first file comprising at least a first compressed data set and a first dictionary;
a compression module for generating a second file comprising at least a second compressed data set and a second dictionary;
a merging module for inserting said first compressed data set and said second compressed data set into an overall file, and for merging said first dictionary and said second dictionary in said overall file.

6. The network node according to claim 5, wherein said compression module is further adapted to generate said second file according to at least a dictionary entry which is stored at said network node.

7. The network node according to claim 5, wherein said merging module is further adapted to insert in said overall file a header including an identifier of said network node.

8. The network node according to claim 5, wherein it further comprises a forwarding module for forwarding said overall file according to routing information stored at said network node.

9. A network manager of a telecommunication network, comprising:
receiving means for receiving a file comprising a first compressed data set, a second compressed data set and a sequence of dictionary entries;
a decompression module for decompressing said first compressed data set and said second compressed data set according to said sequence of dictionary entries.

10. The network manager according to claim 9, wherein said decompression module is further adapted to decompress said first compressed data set and said second compressed data set according to at least a dictionary entry which is stored at said network manager.

11. A telecommunication network comprising:
a network node having a receiving means for receiving a first file comprising at least a first compressed data set and a first dictionary, a compression module for generating a second file comprising at least a second compressed data set and a second dictionary, and a merging module for inserting said first compressed data set and said second compressed data set into an overall file, and for merging said first dictionary and said second dictionary in said overall file, and
a network manager according to claim 9.
